(19) United States
(12) Patent Application Publication
(10) Pub. No.: US 2007/0220352 A1
(43) Pub. Date: Sep. 20, 2007

(54) Method and apparatus for measuring signals in a semiconductor device

(76) Inventors: Adrian M. Hernandez, Colorado Springs, CO (US); Joel D. Woodward, Colorado Springs, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/364,469

(22) Filed: Feb. 28, 2006

(51) Int. Cl. G06F 11/00

(52) U.S. Cl. 714/39

(57) ABSTRACT

A method and apparatus for testing a semiconductor device captures a first set of digital data in internal memory and captures a second set of digital data in external memory. The first and second sets of collected digital data are time correlated. The time correlated data is presented simultaneously and relative to a same time scale.

### BACKGROUND

Test and debug of field programmable gate array (herein “FPGA”) functionality is commonly performed using some number, commonly four to thirty-two, visibility ports or test pins built into the FPGA design. The test pins are specifically included in the FPGA design for test and debug of the internal FPGA architecture and displace what might otherwise be used as a functional FPGA external pin. Accordingly, it is beneficial to minimize the number of visibility ports so that a larger percentage of the FPGA external pins may be used for functional purposes. Because test and debug typically requires more test pins than can practically and cost efficiently be provided, it is known to programmatically select a set of internal FPGA signals for presentation at the test pins. U.S. patent application Ser. No. 10/923,460 entitled “Apparatus and Method for Dynamic Circuit Probing of Field Programmable Gate Arrays” filed Aug. 20, 2004 (herein “the '460 application”), the contents of which are specifically incorporated by reference, discloses programmatic selection of internal FPGA signals for routing to the external FPGA test pins for purposes of test and debug using a logic analyzer. Debug, therefore, becomes an iterative process with different FPGA signals routed to the test pins at each iteration and collection and presentation of the collected data using an external logic analyzer.

Also known is provision of an FPGA logic analyzer core for incorporation into the FPGA. The logic analyzer core is provided as part of the FPGA for the specific purpose of test and debug. The logic analyzer core provides simple triggering and limited capture of FPGA digital signals that are not available external of the FPGA. After the trigger and capture, the stored data may be downloaded to a computer and displayed. A user of the logic analyzer core conducts an iterative debug where different internal signals are routed to the logic analyzer core for capture and display. Because memory dedicated to the logic analyzer core is not available as part of the FPGA final functionality, one challenge with the on-chip logic analyzer is that memory depth is limited for purposes of test and debug and only a limited amount of test data may be captured at each iteration. Another challenge is that incorporation of the logic analyzer core into an FPGA can change the FPGA line routing, relative timing and, therefore, the operation of the device.

Some FPGA test and debug tasks benefit from the fully featured external logic analyzer. While it is possible to implement additional features in the logic analyzer core, the increase in logic analyzer core features, requires a larger core adding cost and complexity to the detriment of the final FPGA product.

There is a need, therefore, to combine the benefits of access to internal FPGA signals consistent with a logic analyzer core with the benefits provided by a fully featured external logic analyzer.

### BRIEF DESCRIPTION OF THE DRAWINGS

An understanding of the present teachings can be gained from the following detailed description, taken in conjunction with the accompanying drawings of which like reference numerals in different drawings refer to the same or similar elements.

FIG. 1 illustrates an FPGA in communication with an external logic analyzer according to the present teachings.

FIG. 2 is a block diagram of a logic analyzer core according to the present teachings.

FIGS. 3 and 4 show flow charts of two different embodiment of a method according to the present teachings.

FIGS. 5 and 6 illustrate example displays of data collected according to the present teachings. As one of ordinary skill in the art appreciates, displays and graphical user interfaces may have many different formats as varied as the people who view them. The example displays are, therefore, merely illustrative of two possible displays out of the many that are possible.

### DETAILED DESCRIPTION

In the following detailed description, for purposes of explanation and not limitation, example embodiments disclosing specific details are set forth in order to provide an understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the example embodiments. Such methods and apparatus are considered to be within the scope of the present teachings.

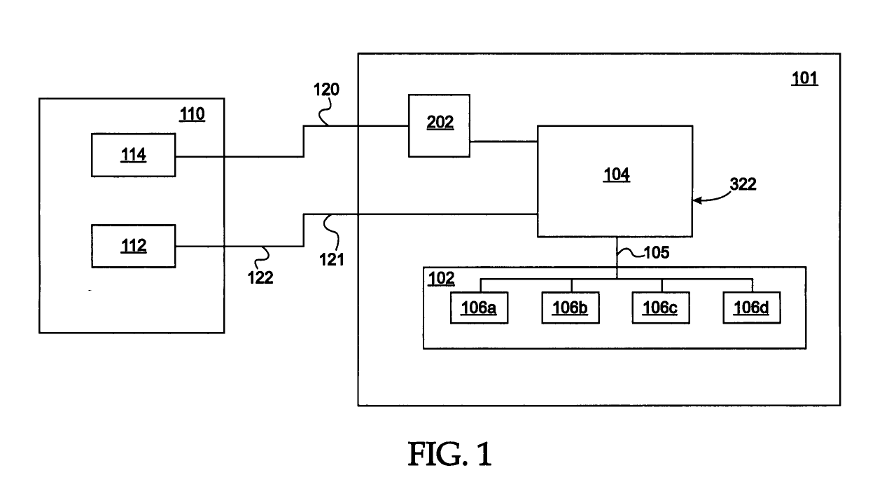

With specific reference to FIG. 1 of the drawings, there is shown an embodiment according to the present teachings in which an FPGA 101 is connected to a logic analyzer 110 for digital test and debug. The logic analyzer 110 has a control component 114 and a data measurement component 112. A Ttrace core 104 according to the present teachings is a FPGA core with a logic analysis function that may be made a part of the FPGA fabric and used with a logic analyzer 110 for the purposes of test and debug. One or more of the Ttrace cores 104 may be incorporated in a FPGA design depending upon the test and debug needs of the particular FPGA. As one of ordinary skill in the art appreciates, a logic analyzer may be a dedicated instrument or a general purpose computer configured with hardware and processes to perform the logic analysis function. These and other devices performing a logic analysis function are considered “logic analyzers” as used herein.

The Ttrace core 104 as part of the FPGA fabric has connection to internal signals 105 of the FPGA. The internal signals 105 originate from one or more system on a chip 102 comprising one or more FPGA cores 106a, 106b, 106c, 106d. The internal signals 105 are those signals, also referred to as communications lines that are used to interconnect constituent circuitry of the FPGA, but are not available as signal pins external to the FPGA. In a specific embodiment, there are a number of test pins 121 that are made available for probing by external measurement equipment and are dedicated to test and debug. The test pins 121 may not be useful once debug is complete. Therefore, there is incentive to minimize the total number of test pins 121 on an FPGA so that more pins may be made available for normal FPGA operation and integration into a system. The Ttrace core 104 accepts the internal signals 105 and programmatically connects one or more of the internal signals 105 to the test pins 121 of the FPGA 101. A test signal bus 122 is then able to carry test signals from the test pins 121 of the FPGA 101 to the data measurement component 112 of the logic analyzer 110.

The Ttrace core 104 is programmed and monitored by the control component 114 through connection 120 via a communications port 202 on the FPGA 101. The control component 114 maintains dialogue with Ttrace status and control core registers 313 to monitor and control the Ttrace core 104 functionality via the communications port 202. The communications port 202 is also used to download status and data from the Ttrace core. In a specific embodiment, the communications port 202 is a serial communications bus operating in accordance with any of a number of serial communication standards, such as IEEE 1149.1, commonly referred to as JTAG. Beneficially, the JTAG standard provides for low bandwidth, ready availability, knowledge base in the industry, and straightforward integration with FPGA fabric.

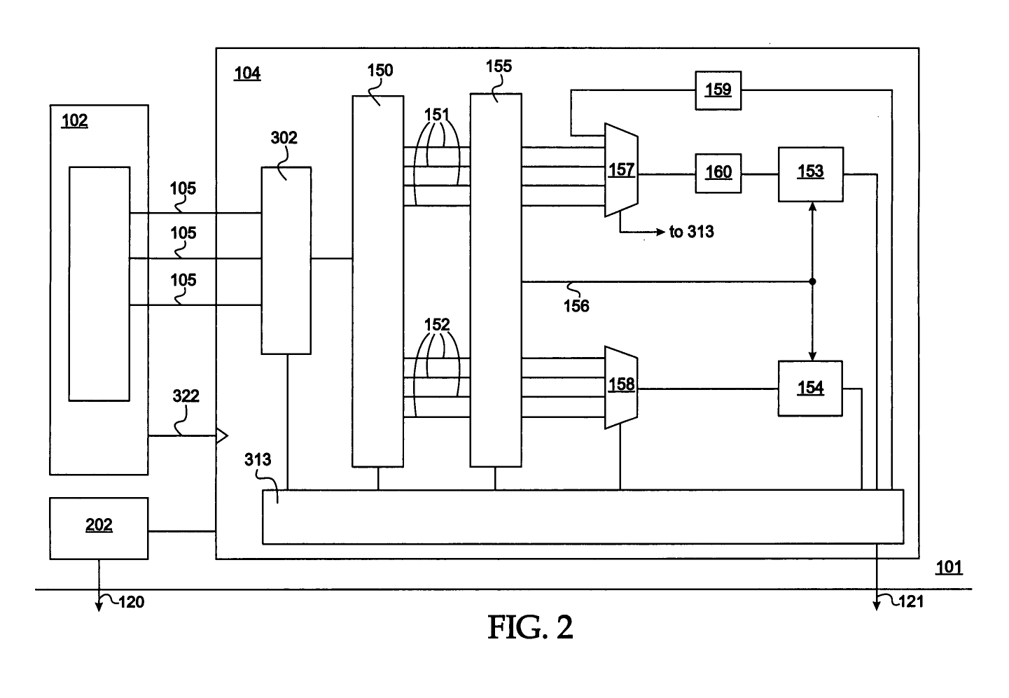

With specific reference to FIG. 2 of the drawings, there is shown a more detailed block diagram of an FPGA including the Ttrace core 104 according to the present teachings. Signal buffers 302 that are part of the Ttrace core 104 accept the FPGA internal signals 105 and connect the internal signals 105 to signal router 150. One of the functions of the core registers 313 is to programmatically enable or disable the signal buffers 302. Specifically, the signal buffers 302 may be enabled for the test and debug phase of the FPGA development and then disabled for normal operation when debug is complete. Operations of the Ttrace core 104 are driven by clock 322. An embodiment having multiple Ttrace cores 104 is able to accommodate multiple clocks 322, wherein there is a single clock 322 per Ttrace core 104.

A plurality of external signal banks 151a-151c and a plurality of internal signal banks 152a-152c accept signals delivered by the signal router 150. The internal and external signal banks 151, 152 can be any width. In a specific embodiment, all internal signal banks 152 are the same width and all external signal banks 151 are the same width. Information regarding the width of each of the signal banks 151, 152 is stored is the status and control registers 313 for download into the control component 114. The control component 114 is then able to understand the Ttrace core configuration and proceed accordingly. Beneficially, the flexibility of the Ttrace core configuration permits the control component 114 to automatically adapt to different Trace core configurations. Commonly, but not necessarily, the external signal bank 151 has a width equal to a number of test pins 121 that are available from the Ttrace core 104. Commonly, but not necessarily, the internal signal banks 152 have a width equal to a width of internal test memory storage 154. As an example, the external signal bank can be 16 pins wide and the internal signal bank 152 can be 1024 pins wide. The signal router 150 is programmed with the core registers 313 to connect at least one of the signals from the signal buffers 302 to any number of the external and internal signal banks 151, 152. Specifically, the router 150 is able to connect any one of the signals from the signal buffers 302 to anywhere from all to none of the external and internal signal banks 151, 152. Beneficially, the router 150 provides extensive flexibility in defining the type of data for collection during the test and debug operations.

The external and internal signal banks 151, 152 define which of the internal signals 105 may be captured by the logic analyzer 110 through the test pins 121, which of the internal signals 105 may be captured by the internal memory 154, and which grouping of the internal signals are used to establish trigger criteria. The external and internal signal banks 151, 152 connect to comparator 155. The comparator 155 is programmed by the control component 114 of the logic analyzer via the communications port 202 and core registers 313. The core registers 313 specify one of the signal banks 151 or 152 as a trigger source and also specify a digital pattern against which the values of the trigger source are compared. When the specified pattern for the trigger source is presented at the comparator 155 during a test, the comparator 155 initiates trigger signal 156. The trigger signal 156 is presented at one of the test pins 121 and is connected to the logic analyzer 110 via a signal bus 122 from the test pins 121. In a specific embodiment, the trigger signal 156 is a single pulse and it positions the data collected by the logic analyzer 110 in time for a single run of a test.

External signal multiplexer 157 and internal signal multiplexer 158 accept the external signal banks 151 and internal signal banks 152, respectively. Both the external and internal signal multiplexers 157, 158 are programmed via the core registers 313 to select one of the external and internal signal banks 151, 152 for presentation at the outputs of the multiplexers 157, 158. A width of the registers that control the internal and external signal multiplexers 157, 158 is defined by the number of inputs available at each multiplexer's input. Each multiplexer 157, 158, therefore, presents one of its respective inputs at its respective outputs. The external signal multiplexer 157 also accepts an output of a test component 159. The external signal multiplexer 157 presents at its output, the selected external signal bank 151 or test component output to a time domain multiplexer module 159. The function and purpose of the test component and time domain multiplexer module is described in the '460 patent application.

The output of the time domain multiplexer module 160 is connected to test pin port 153. The test pin port 153 is connected to the test pins 121 of the FPGA 101 through the core registers 313. If time domain multiplexing is not used, the output of the external signal multiplexer 157 is presented at the test pin port 153 at a frequency defined by the clock 322. The clock 322 is also presented as one of the test pins 121. In one embodiment, there is a dedicated test pin 121 for the clock 322. In another embodiment, the clock 322 is presented to the signal buffers 302, routed through router 150, and made available as one or more of the signals at the test pin port 153. The logic analyzer 110 collects state data from the test pins 121 using the clock 322. Upon receipt of the trigger signal 156, also presented as one or more of the test pins 121, the logic analyzer 110 is able to position the collected data in time relative to the trigger signal 156. As one of ordinary skill in the art appreciates, the logic analyzer 110 may be programmed to collect data and position the trigger signal at the beginning, middle or end of the collected data.

The output of the internal memory multiplexer 158 is connected to internal memory 154. The internal memory 154 is part of or accessible by the Ttrace core 104 and may comprise either block RAM or distributed memory. In most cases, the amount of memory is limited because it takes space on the FPGA that would otherwise be dedicated to FPGA functions not associated with test and debug. It is possible, however, to collect data from a large number of internal signals 105 in the internal memory 154 because it does not require use of any of the test pins 121. Beneficially, therefore, there is visibility into the internal pin signal activity without using the dedicated test pins 121. The trigger signal 156 is also delivered to the internal memory 154 and upon receipt of the trigger signal 156, data from the output of the internal signal multiplexer 158 is collected in the internal memory 154. When internal signal data collection is complete, the contents of the internal memory 154 are sent to the logic analyzer 110 via the core registers 313 and communications port 202.

The logic analyzer 110, therefore, receives data collected from the output pins 153 of the FPGA 104 and data collected from the internal memory 154 of the FPGA 104. It is desirable to synchronize in time, the data collected in internal memory 154 with the data collected in external memory. In a specific embodiment, data collection into internal memory may begin before the trigger signal 156 and data is presented at the output pins 513 of the FPGA 104. In a specific embodiment, the asserted trigger signal 156 initiates data collection into internal memory 154. In specific embodiments of the Ttrace core 104, there may be a number of cycles of the clock 322 before the trigger signal 156 and data is presented at the test pins 121. The difference in clock cycles between the time the trigger 156 initiates internal data collection and the time the trigger 156 is presented with the data at the output pins 121 comprises a trigger delay. The trigger delay is deterministic and repeatable depending upon a specific design of the Ttrace core 104. In a specific embodiment, therefore, the trigger delay represented as a number of clock cycles is stored as one of the core registers 313. The logic analyzer 110 accesses the trigger delay via the communications port 202 and based upon the delay value in the core register 313 that represents the trigger delay, is able to accurately position the data collected in internal memory relative to the trigger signal 156 and the data collected by the logic analyzer 110 from the test pins 121. In another specific embodiment, there is a deterministic and repeatable first delay between assertion of the trigger signal 156 and initiation of data collection into the internal memory and a deterministic and repeatable second delay between assertion of the trigger signal 156 and presentation of the trigger signal 156 and data at the external pins 121. In this embodiment, two different core registers 313 are made available via the communications port 202 for access by the external logic analyzer for the purpose of properly time correlating the data collected in internal and external memory relative to the trigger signal 156.

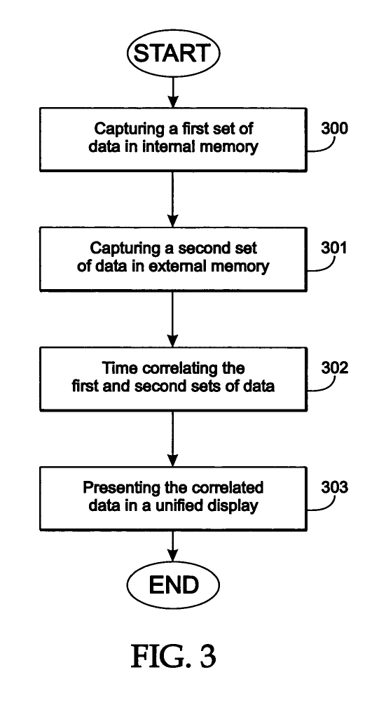

With specific reference to FIG. 3 of the drawings, there is shown a flow chart representing an embodiment according to the present teachings in which a first set of data is captured 300 in internal memory 154 and a second set of data is captured 301 in external memory 112. The first and second sets of data are time correlated 302 and presented 303 in a unified display.

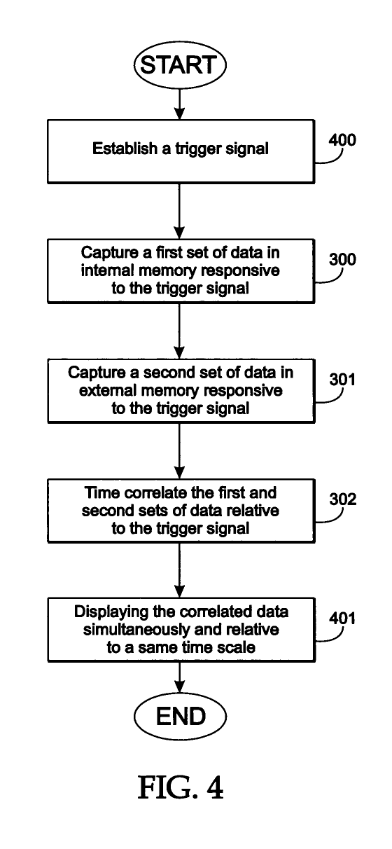

With specific reference to FIG. 4 of the drawings, there is shown a flow chart of another embodiment according to the present teachings in which the captured data is time correlated relative to the trigger signal. Specifically, an embodiment of a method according to the present teachings establishes 400 a trigger signal 156. Responsive to the trigger signal 156, a first set of data is captured 300 in internal memory 154 and a second set of data is captured 301 in external memory 112. The first and second sets of data are time correlated relative to the trigger signal 156 and displayed 401 simultaneously and relative to a same time scale.

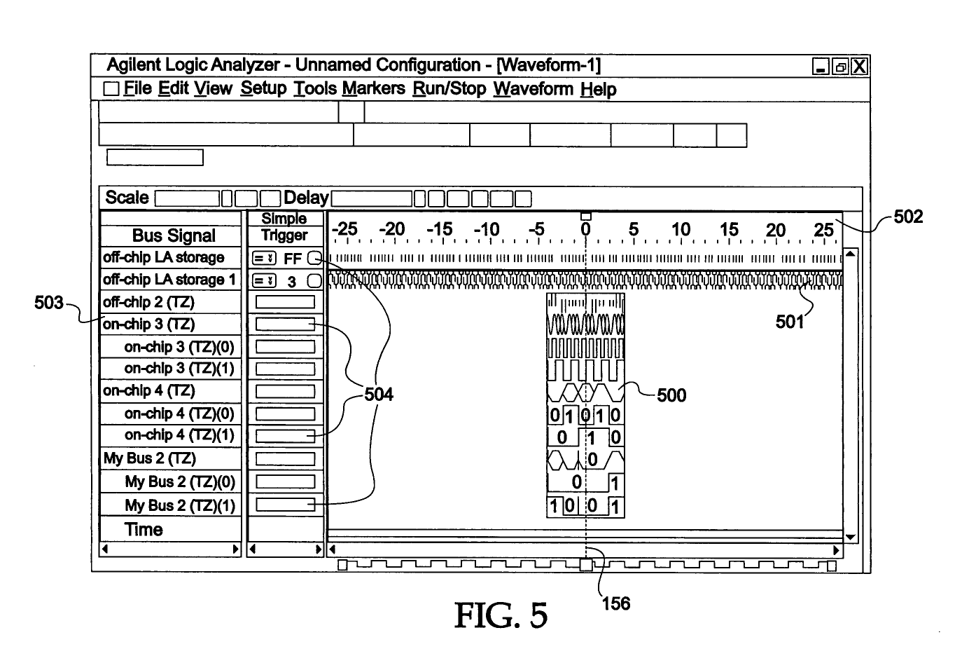

With specific reference to FIG. 5 of the drawings, there is shown an example display according to the present teachings in which presentations of first and second sets of data are time-correlated and positioned relative to the trigger signal 156. The first and second sets of data are presented simultaneously and on a same time scale 502 to show relative time positioning. The timing presentation for the first set of data 500 represents data gathered for signals internal to the FPGA 152. The timing presentation for the second set of data 501 represents timing data gathered from the external test pins 121 of the FPGA 101. The timing presentation further includes an indication of the position of the trigger signal 156 relative to the first and second sets of data 500, 501 and also includes labels 503 for each signal where data is collected.

Trigger options according to the present teachings include specifying trigger criteria for one or more of the internal signal banks 152. The trigger criteria may be established via a graphical user interface (“GUI”) by entering a trigger state into one or more trigger state input frames 504 associated with established internal signal banks 152. When the trigger criteria are met during run time, the Ttrace core 104 asserts the trigger signal 156. In a specific embodiment, the user is able to configure internal data collection relative to the trigger signal 156 so that the trigger signal 156 is positioned at the beginning middle or end of the acquisition. As shown in the example, a trigger signal positioned at 50% pre-store is located in the center of the collected data. Based upon a priori knowledge of the data collection rate and the total amount of internal memory 154, the logic analyzer 110 is able to determine where to place the data collected in internal memory relative to the trigger signal 156. Data is also collected in the external memory relative to the trigger signal 156. As an example, data may be collected immediately upon receipt of the trigger signal 156 or the trigger signal 156 may arm the logic analyzer 110 to trigger on different established criteria based upon data collected from the test pins 121. The arming criteria may be defined in a similar fashion based on input into the trigger state input frames 504. In the example, timing relative to the trigger signal 156 is known for both the internal data collection and external data collection. In this way, the external logic analyzer 110 is able to time correlate the data collected in the internal memory 154 relative to data collected externally. As one of ordinary skill in the art appreciates from a review of FIG. 5, the resulting display presents data collected from few signals over a relatively long sample time together with data collected from a larger number of signals over a relatively short period of time. Measurement of the time difference between data collected in internal memory 154 and data collected in external memory 112 relative to the trigger signal 156 permits time-correlation between the two sets of collected data. The time-correlated data are displayed simultaneously to show relative activity between the two sets of data. The resulting display resembles a T and is termed herein a “Ttrace”. This display reflects the fact that the external memory 112 is deeper than the internal memory 154, but the external memory 112 has fewer visibility pins or test pins 121 from which to collect the data relative to the internal memory 154. This display further reflects the fact that the internal memory 154 is shallower than the external memory 112, but the internal memory 154 has access to a larger number of internal signals from which to collect the data. Consequently, with preparation and thought, the shallower memory and larger number of internal signals combined with the deeper memory and fewer number of external signals provide additional insight into the operation of the FPGA at speed that is not available under the prior art. In an iterative test and debug process, the additional insight provides a shorter time to realize a final functional FPGA product.

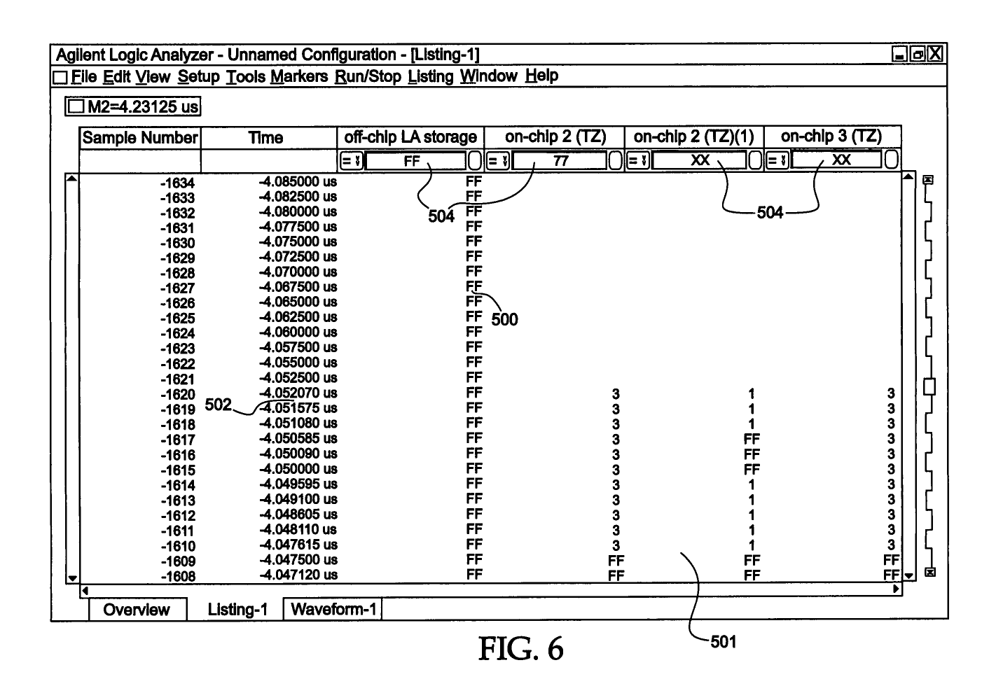

With specific reference to FIG. 6 of the drawings, there is shown another possible display according to the present teachings. The first set of data 500 which is the data collected in the internal memory 154 and the second set of data 501 which is the data collected in the external memory are presented simultaneously in a state format relative to the same time scale 502. For ease of viewing, the trigger signal 156 may be represented as a horizontal line across the time and data sets, although it is not shown in the illustration. In this embodiment of a display, time is represented as a positive or negative value to show a position in time relative to the trigger signal 156.

Embodiments of the teachings are described herein by way of example with reference to the accompanying drawings describing a Ttrace core and its constituent elements. Other variations, adaptations, and embodiments of the present teachings will occur to those of ordinary skill in the art given benefit of the present teachings. For example, the present teachings may be adapted for application to an application specific integrated circuit (“ASIC”). While ASICs are not as readily reconfigurable as FPGAs, the present teachings may be adapted to a non-iterative test process for an ASIC.

1. A method of testing a semiconductor device comprising
Capturing a first set of data in internal memory,
Capturing a second set of test data in external memory, Time correlating the first and second sets of data, and
Presenting the correlated data in a unified display.

2. A method as recited in claim 1 and further comprising establishing a trigger and time correlating further comprises locating the first and second sets of data in time relative to the trigger.

3. A method as recited in claim 2 wherein establishing further comprises defining at least one internal signal upon which the trigger is based.

4. A method as recited in claim 2 wherein establishing further comprises defining assertion criteria for the trigger.

5. A method as recited in claim 1 and further comprising capturing the second set of data in an external logic analyzer, transferring the first set of data to the logic analyzer, and presenting further comprises displaying the correlated data on the logic analyzer.

6. A method as recited in claim 5 and further comprising establishing a trigger and time correlating further comprises locating the first and second sets of data in time relative to the trigger and presenting further comprises displaying the first and second sets of data simultaneously and relative to a same time scale.

7. A method as recited in claim 1 and further comprising accepting a plurality of internal signals assigning at least one of the internal signals to at least one external memory signal bank and assigning at least another one of the internal signals to at least one internal memory signal bank, the internal memory signal bank being a source for the first set of data and the external memory signal bank being a source for the second set of data.

8. A method as recited in claim 7 and wherein the step of assigning comprises configuring the semiconductor device.

9. A method as recited in claim 8 wherein configuring comprises storing values into core registers of the semiconductor device.

10. A method as recited in claim 8 wherein the step of configuring comprises communicating with the semiconductor device via a JTAG compliant communications port.

11. A method as recited in claim 7 wherein selecting a trigger further comprises selecting one signal from the group consisting of the at least one internal memory signal bank and the at least one external memory signal bank and establishing a pattern for the selected memory signal bank that defines criteria for assertion of the trigger.

12. A method as recited in claim 1 wherein the semiconductor device is a field programmable gate array (“FPGA”) and further comprising repeating capturing, capturing, time correlating, and presenting after reconfiguring the FPGA.

13. A method of testing a semiconductor device comprising:
Establishing a trigger signal,
Capturing a first set of data in internal memory responsive to the trigger signal,
Capturing a second set of data in external memory responsive to the trigger signal,
Time correlating the first and second sets of data relative to the trigger signal, and
Presenting the correlated data simultaneously and relative to a same time scale.

14. A method as recited in claim 13 wherein presenting comprises displaying on an external logic analyzer.

15. A method as recited in claim 13 wherein presenting comprises presenting on a unified display.

16. A method as recited in claim 13 wherein time correlating further comprises locating in time the first and second sets of data relative to the trigger.

17. A method as recited in claim 13 wherein establishing further comprises defining assertion criteria for the trigger.

18. A method as recited in claim 13 and further comprising capturing the second set of test data in an external logic analyzer, transferring the first set of data to the logic analyzer, and the step of displaying further comprises displaying the correlated data on the logic analyzer.

19. A method as recited in claim 13 wherein time correlating further comprises locating the first and second sets of data in time relative to the trigger.

20. A method as recited in claim 13 and further comprising accepting a plurality of internal signals assigning at least one of the internal signals to at least one external signal bank and assigning at least another one of the internal signals to at least one internal memory signal bank, the internal signal bank being a source for the first set of data and the external signal bank being a source for the second set of data.

21. A method as recited in claim 20 and wherein the step of assigning comprises configuring the semiconductor device.

22. A method as recited in claim 21 wherein configuring comprises storing values into core registers of the semiconductor device.

23. A method as recited in claim 21 wherein configuring comprises communicating with the semiconductor device via a JTAG compliant communications port.

24. A method as recited in claim 20 wherein the step of selecting a trigger further comprises selecting one signal from the group consisting of the at least one internal signal bank and the at least one external signal bank and establishing a pattern for the selected signal bank that defines criteria for assertion of the trigger.

25. A method as recited in claim 13 wherein the semiconductor device is a field programmable gate array (“FPGA”).

26. A method as recited in claim 25 and further comprising reconfiguring the FPGA and repeating establishing, capturing, capturing, time correlating, and presenting after reconfiguring the FPGA.

27. An apparatus for testing a semiconductor device comprising:
A semiconductor device with at least one logic analyzer core, the logic analyzer core comprising a signal router, a signal selector, wherein an output of the signal selector is directed to an internal memory, an external data selector, wherein an output of the external data selector is directed to an external memory, and
A logic analyzer comprising the external memory and a presentation device, the logic analyzer adapted to communicate with the logic analyzer core and adapted to accept data captured in the internal memory and present the data captured in the internal memory relative to the data captured in the external memory.

28. An apparatus as recited in claim 27 and further comprising a trigger generator adapted to establish a trigger signal against which the data in the internal memory and the data in the external memory are presented.

29. An apparatus as recited in claim 28 wherein the trigger generator comprises a comparator and wherein the comparator is adapted to accept a pattern as criteria for assertion of the trigger signal.

30. An apparatus as recited in claim 27 and further comprising a communications port adapted for communications between the logic analyzer core and the logic analyzer.

31. An apparatus as recited in claim 30 wherein the communications port is JTAG compliant.

32. An apparatus as recited in claim 27 wherein the signal router accepts a plurality of internal signals and is adapted to connect any one of the internal signals to any number of at least one internal memory signal bank and at least one external memory signal bank.

33. An apparatus as recited in claim 32 wherein any number includes zero and at least one.

34. An apparatus as recited in claim 32 wherein there are a plurality of the internal memory signal banks.

35. An apparatus as recited in claim 34 wherein the internal data selector selects one of the plurality of the internal memory signal banks.

36. An apparatus as recited in claim 32 wherein there are a plurality of external memory signal banks.

37. An apparatus as recited in claim 36 wherein the external test data selector selects one of the plurality of the external memory signal banks.

38. An apparatus as recited in claim 27 wherein the semiconductor device is a field programmable gate array (“FPGA”).
